(19) United States
(12) Patent Application Publication
(10) Pub. No.: US 2018/0210890 A1
(43) Pub. Date: Jul. 26, 2018

(54) APPARATUS AND METHOD FOR PROVIDING CONTENT MAP SERVICE USING STORY GRAPH OF VIDEO CONTENT AND USER STRUCTURE QUERY

(71) Applicant: Electronics and Telecommunications Research Institute, Daejeon (KR)

(72) Inventors: Jeong Woo SON, Daejeon (KR); Sang Kwon KIM, Daejeon (KR); Sun Joong KIM, Sejong-si (KR); Seung Hee KIM, Daejeon (KR); Hyun Woo LEE, Seoul (KR)

(73) Assignee: Electronics and Telecommunications Research Institute, Daejeon (KR)

(21) Appl. No.: 15/689,401

(22) Filed: Aug. 29, 2017

(30) Foreign Application Priority Data
Jan. 25, 2017 (KR) 10-2017-0012056

(51) Int. Cl. G06F 17/30; G06K 9/46

(52) U.S. Cl. CPC G06F 17/3079; G06F 17/30858; G06F 17/3084; G06F 17/30831; G06K 9/46

(57) ABSTRACT

The present invention relates to an apparatus and method for providing a content map service using a story graph of video content and a user structure query. The apparatus according to an embodiment of the present includes: a story graph generating apparatus configured to extract video entities contained in video content and entity relations between the entities, and generate a story graph on the basis of the extracted entity relations; a story graph database configured to store the generated story graph; a structure query input apparatus configured to receive a user structure query in the form of a graph; a story graph matching apparatus configured to calculate a similarity between the story graph and the input user structure query from a similar sub-structure, and select a matching video on the basis of the calculated similarity; and a visualization apparatus configured to visualize the input user structure query and the video matching the user structure query in the story graph and provide a visualization result to a user.

### CROSS-REFERENCE TO RELATED APPLICATION

This application claims priority to and the benefit of Korean Patent Application No. 10-2017-0012056, filed on Jan. 25, 2017, the disclosure of which is incorporated herein by reference in its entirety.

### BACKGROUND

### 1. Field of the Invention

The present invention relates to information retrieval and content mining technology, and more particularly, to an apparatus and method for providing a content map service using a story graph of video content and a user structure query which allows for deriving a story graph that represents keywords, which imply the content of a video, and relations between the keywords, and visualizing and providing video content corresponding to all or a part of a user's query together with the user structure query through a comparison between the user's structured query defined by keywords and relations between keywords with the story graph derived from the video.

### 2. Discussion of Related Art

Many domestic and foreign search providers, such as Google, Youtube, and Naver, provide keyword-based video search services. Since the proportion of video content among various contents on the Internet has increased, the importance of video search services has been highlighted. As opposed to conventional contents which are composed of text or Hypertext Markup Language (HTML), a video intuitively delivers the content and thus the content can be easily understood. With the vitalization of the video search service, a market of a size that cannot be ignored by the existing broadcasting operators has been established, and currently, Internet portal service providers have begun to produce their own contents beyond the service of providing previously broadcast content, such as Naver TV cast. Contrary to the increasing importance of video-based services, the form of service itself does not depart from the conventional form.

The video content contains temporally dynamic content. Emerging entities may establish relations of various forms over time, even within a single content, and relations established between the entities may disappear. Thus, there are limitations in representing the video content using a plurality of keywords, but in a majority of services, a single video content is represented by a set of keywords extracted from user tags or the like. In this case, a user query may be defined as a set of keywords, like in a conventional search for text and HTML documents, and a video is provided through keyword matching. As described above, a technique for representing video content can be easily implemented by expansion of the existing service and can provide the video content to the user without causing a significant sense of difference, but has limitations in performing a precise search for the content of a video. In addition, in the case of a video having many contents, a user needs to manually search for an intended content.

### SUMMARY OF THE INVENTION

Embodiments of the present invention are directed to providing an apparatus and method for providing a content map service using a story graph of video content and a user structure query which allows for deriving a story graph of video content and combining and providing the video content matching a structured user structure query with all or a part of an input query.

In addition, embodiments of the present invention are directed to providing an apparatus and method for servicing a content map using a story graph of video content and a user structure query which allows for providing a user with both video content matching all or a part of an input structured user structure query and the user structure query within a visualization tool, unlike the related art which simply lists and provides search results based on a keyword-based query.

In one general aspect, there is provided an apparatus for providing a content map service using a story graph of video content and a user structure query, the apparatus including: a story graph generating apparatus configured to extract video entities contained in video content and entity relations between the entities, and generate a story graph on the basis of the extracted entity relations; a story graph database configured to store the generated story graph; a structure query input apparatus configured to receive a user structure query in the form of a graph; a story graph matching apparatus configured to calculate a similarity between the story graph and the input user structure query from a similar sub-structure, and select a matching video on the basis of the calculated similarity; and a visualization apparatus configured to visualize the input user structure query and the video matching the user structure query in the story graph and provide a visualization result to a user.

The story graph generating apparatus may include a video entity extractor configured to extract video entities of the input video content, and an entity relation extractor configured to generate a story graph consisting of a node weight list and an edge matrix by extracting entity relations between the extracted video entities.

The story graph generating apparatus may further include a story graph smoothing unit configured to selectively expand the entities and the entity relations using external data and identify information about entity relations between indirectly connected entities using the generated node weight list and edge matrix.

The structure query input apparatus may include a structure query interface configured to receive keywords corresponding to nodes and relation information between the nodes, a structure query expander configured to expand the user structure query through the keywords associated with the input nodes using external data and expand the user structure query by extracting relation information between the nodes from the external data, and a structure query smoothing unit configured to generate connection information between indirectly connected nodes through smoothing of the user structure query.

The story graph matching apparatus may include a story graph requester configured to request a related story graph on the basis of a keyword corresponding to a node included in the user structure query and receive the story graph from a database, a story graph matching unit configured to identify the similar sub-structure through node alignment between the user structure query and the story graph, calculate the similarity between the user structure query and the story graph according to a weight of the identified similar sub-structure and match the user structure query to the story graph, and a story graph alignment unit configured to align and provide video content corresponding to the user structure query through the matching story graph.

The story graph matching unit may calculate the similarity by combining weights of constituent nodes of the identified sub-structure with weights of constituent edges of the sub-structure.

The story graph alignment unit may re-align the alignment result based on the calculated similarity on the basis of at least one of the user's preference of video content, consistency of a video with a previous search result, and importance of video content.

The visualization apparatus may visualize an entire region of the input user structure query, visualize a selected region of the user structure query which is selectively queried by the user, connect the input user structure query with the video matching the user structure query for each of the selected regions and provide the result.

The visualization apparatus may confirm a video content list associated with the connected video using a re-selection function, select one or more video contents from the video content list, and connect the selected one or more video contents with the corresponding user structure query.

The visualization apparatus may determine a hierarchical structure of user structure queries on the basis of a position and size of a region of the selected user structure query with respect to the entire region, and visualize a result for a structured query at a specific level through a depth adjustment function for the determined hierarchical structure.

In another aspect of the present invention, there is provided a method of providing a content map service using a story graph of video content and a user structure query, the method including: extracting video entities contained in video content and entity relations between the entities, and generating a story graph on the basis of the extracted entity relations; receiving a user structure query in the form of a graph; calculating a similarity between the story graph and the input user structure query from a similar sub-structure, and selecting a matching video on the basis of the calculated similarity; and visualizing the input user structure query and the video matching the user structure query in the story graph and providing a visualization result to a user.

The generating of the story graph may include extracting video entities of the input video content, and generating a story graph consisting of a node weight list and an edge matrix by extracting entity relations between the extracted video entities.

The generating of the story graph may further include selectively expanding the entities and the entity relations using external data and identifying information about entity relations between indirectly connected entities using the generated node weight list and edge matrix.

The receiving of the user structure query may include receiving keywords corresponding to nodes and relation information between the nodes, expanding the user structure query through the keywords associated with the input nodes using external data, and expanding the user structure query by extracting relation information between the nodes from the external data, and generating connection information between indirectly connected nodes through smoothing of the user structure query.

The selecting of the matching video may include requesting a related story graph on the basis of a keyword corresponding to a node included in the user structure query and receiving the story graph, identifying the similar sub-structure through node alignment between the user structure query and the story graph, calculating the similarity between the user structure query and the story graph according to a weight of the identified similar sub-structure and matching the user structure query to the story graph, and aligning and providing video content corresponding to the user structure query through the matching story graph.

The matching may include calculating the similarity by combining weights of constituent nodes of the identified sub-structure with weights of constituent edges of the sub-structure.

The aligning and providing of the video content may include re-aligning the alignment result based on the calculated similarity on the basis of at least one of the user's preference of video content, consistency of a video with a previous search result, and importance of video content.

The providing of the visualization result may include visualizing an entire region of the input user structure query and visualizing a selected region of the user structure query which is selectively queried by the user and connecting the input user structure query with the video matching the user structure query for each of the selected regions and providing a result.

The providing of the visualization result may further include confirming a video content list associated with the connected video using a re-selection function, selecting one or more video contents from the video content list, and connecting the selected one or more video contents with the corresponding user structure query.

The providing of the visualization result may further include determining a hierarchical structure of user structure queries on the basis of a position and size of a region of the selected user structure query with respect to the entire region and visualizing a result for a structured query at a specific level through a depth adjustment function for the determined hierarchical structure.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram illustrating a configuration and operations of an apparatus for providing a content map service using both a story graph of video content and a user structure query according to an embodiment of the present invention;

FIG. 2 is a diagram illustrating a configuration and operations of a story graph generating apparatus which generates a story graph of video content according to an embodiment of the present invention;

FIG. 3 is a diagram illustrating a configuration and operations of a structure query input apparatus which receives a structured query of a user according to an embodiment of the present invention;

FIG. 4 is a diagram illustrating a configuration and operations of a story graph matching apparatus which matches all or a part of the query graph selected by a user to a story graph of video content according to an embodiment of the present invention;

FIG. 5 is a diagram illustrating a configuration and operations of a visualization apparatus which visualizes a user's query graph and a searched video content according to an embodiment of the present invention;

FIG. 6 is a flowchart illustrating a method of providing a content map service using a story graph of video content and a user structure query according to an embodiment of the present invention;

FIG. 7 is a flowchart illustrating a process of generating a story graph which is performed by the story graph generating apparatus according to the embodiment of the present invention;

FIG. 8 is a flowchart illustrating a process of inputting a user structure query which is performed by the structure query input apparatus according to the embodiment of the present invention;

FIG. 9 is a flowchart illustrating a process of matching a story graph which is performed by the story graph matching apparatus according to the embodiment of the present invention; and

FIG. 10 is a flowchart illustrating a process of visualization performed by the visualization apparatus according to the embodiment of the present invention.

### DETAILED DESCRIPTION OF EXEMPLARY EMBODIMENTS

Hereinafter, embodiments of the present invention will be described with reference to the accompanying drawings. Detailed descriptions of the embodiments will be made focusing on what is necessary to understand operations and effects according to the present invention. Meanwhile, technical descriptions which are well-known in the art to which the present invention pertains and are not directly related to the present invention will be omitted in the following description. This is so the subject manner of the present invention is conveyed clearly without it being obscured by the omitted unnecessary descriptions.

In the descriptions of elements of the present invention, elements with the same name may be given different reference numerals in some drawings, and the elements may also be given the same reference numerals in different drawings. Even in such a case, pertinent elements may have different functions in the embodiment or the elements may have the same function in different embodiments. A function of each element should be understood based on the descriptions of each element in a corresponding embodiment.

Embodiments of the present invention relate to a new search technique of searching for video content represented by a story graph, a method of visualizing and providing the found video content, and an apparatus employing the technique and the method. In the embodiments of the present invention, the video content represented by a story graph refers to video content in which the content of the video content is expressed through identification of an object in the video content, or an object derived from text associated with the video and relation information between the object and the video.

Therefore, in the embodiments of the present invention, the video content is visualized as one graph and stored in a database. A user query is also a graph represented by a relation between keywords, rather than by a keyword, video content mapped to all or a part of the graph is searched for, and the found video content and the corresponding part of the query graph are visualized and transmitted to a user.

In this regard, in the embodiments of the present invention, a method of representing input video content as a story graph, receiving a structured query of a user, and visualizing a plurality of video contents for the received query, together with the structured query of the user, and an apparatus employing the method will be described.

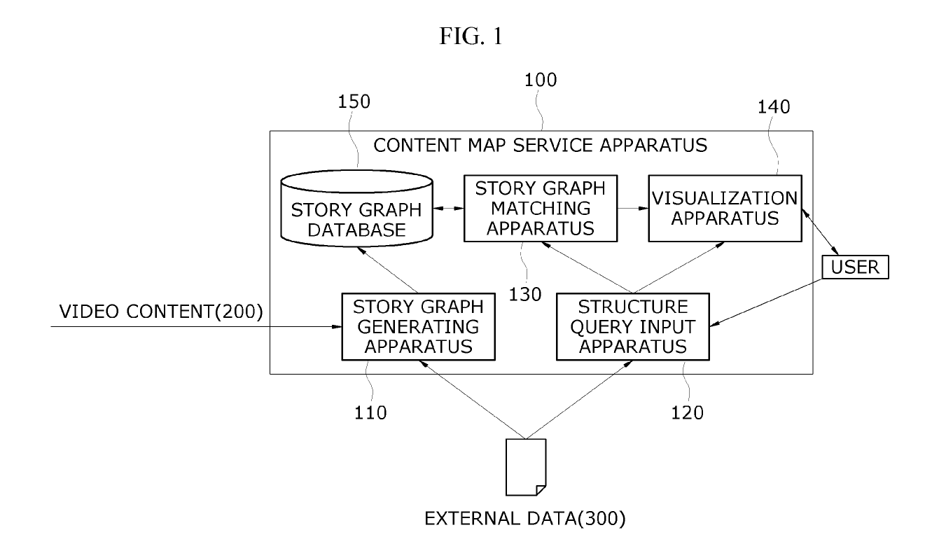

FIG. 1 is a diagram illustrating a configuration and operations of an apparatus for providing a content map service using both a story graph of video content and a user structure query according to an embodiment of the present invention.

As shown in FIG. 1, an apparatus 100 for providing a content map service includes a story graph generating apparatus 110, a structure query input apparatus 120, a story graph matching apparatus 130, a visualization apparatus 140, and a story graph database 150.

Hereinafter, a configuration and operation of each of the elements in the content map service apparatus 100 of FIG. 1 using the story graph of the video content and the user structure query will be described in detail.

The story graph generating apparatus 110 extracts video entities contained in video content 200 and entity relations between the entities, and generates a story graph on the basis of the extracted entity relations. The story graph generating apparatus 110 receives the video content 200, extracts the entities appearing in the video content 200 and the entity relations, and generates a story graph on the basis of the extracted entity relations.

The structure query input apparatus 120 receives a user structure query in the form of a graph. The structure query input apparatus 120 receives the structured user structure query, performs smoothing on the received query, and then performs a query on all or a part of the query graph according to the user's selection.

The story graph matching apparatus 130 calculates a similarity between the story graph and the user structure query input from the structure query input apparatus 120 from a similar sub-structure, and selects a matching video on the basis of the calculated similarity. The story graph matching apparatus 130 links an optimal corresponding video to the user structure query through matching between the story graph of the video content 200 and the user structure query.

The visualization apparatus 140 visualizes the user structure query received from the structure query input apparatus 120 and the video matching the user structure query and provides the visualization result to the user. The visualization apparatus 140 visualizes the video content and the user input query, which are matched to each other in the story graph matching apparatus 130, for the user.

The story graph generated by the story graph generating apparatus 110 is stored in the story graph database 150. As a database, the story graph database 150 is present, in which the story graph generated by the story graph generating apparatus 110 is stored.

Meanwhile, external data 300 may be used to expand the entities observed by the story graph generating apparatus 110 and the structure query input apparatus 120 and information about the entity relations. The user may manually edit some results in the structure query input apparatus 120 and the story graph matching apparatus 130.

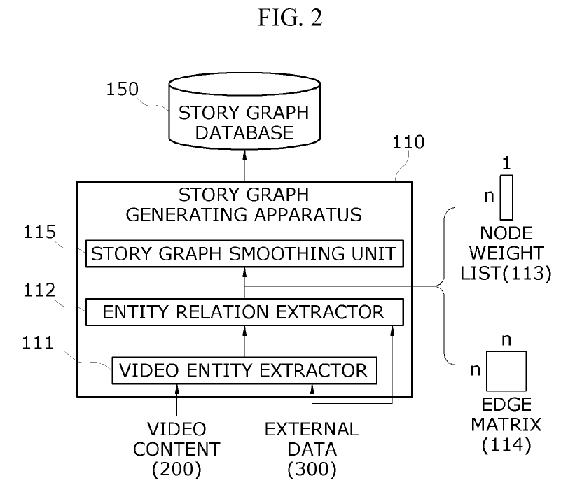

FIG. 2 is a diagram illustrating a configuration and operations of the story graph generating apparatus which generates a story graph of video content according to an embodiment of the present invention.

As shown in FIG. 2, the story graph generating apparatus 110 includes a video entity extractor 111, an entity relation extractor 112, and a story graph smoothing unit 115.

Hereinafter, a configuration and operation of each of the elements in the story graph generating apparatus 110 of FIG. 2 will be described in detail.

The video entity extractor 111 extracts video entities from input video content 200. First, when the video content 200 is input, the video entity extractor 111 performs a video entity extraction function for video entities according to time in the video. In this case, the entity according to time in the video includes a keyword obtained by analyzing at least one piece of external data selected from entities detected and identified through video analysis, background music obtained through voice analysis, recognized words, subtitles, script, and web data.

The entity relation extractor 112 generates a story graph consisting of a node weight list 113 and an edge matrix 114 by extracting entity relations between the video entities extracted by the video entity extractor 111. The entity relation extractor 112 extracts the relations between the entities extracted by the video entity extractor 111. The relations between the entities are generated differently depending on the extracted video entities. For example, in the case of the external data 300, the entity relation extractor 112 may generate a dependency relation, a positional relation, and the like between neighboring keywords as the relation information. In the case of entities obtained through video analysis, the entity relation extractor 112 may obtain the relations between the entities though inclusion relationships and hierarchical relationships between the entities in the video.

When the relations between the entities in the video are generated, two structures, the node weight list 113 and the edge matrix 114, which represent the story graph, are generated. First, the node weight list 113 includes weight information of each node of the story graph which represents an entity. The edge matrix 114 includes information calculated from relation information about connection information between the nodes of the story graph. For example, it may be defined that node weight V ∈ Rⁿ and edge matrix E ∈ R^{n×n}. In this case, n is the number of nodes.

The story graph smoothing unit 115 selectively expands the entities and the entity relations using the external data 300, and identifies information about entity relations between indirectly connected entities using the node weight list 113 and the edge matrix 114, which are generated by the entity relation extractor 112. After generating the story graph, the story graph smoothing unit 115 may selectively smooth the story graph using a stochastic matrix. That is, the story graph smoothing unit 115 generates connection information between the indirectly connected nodes by repeatedly multiplying E and ET. The story graph smoothing unit 115 may be selectively operated by a service manager.

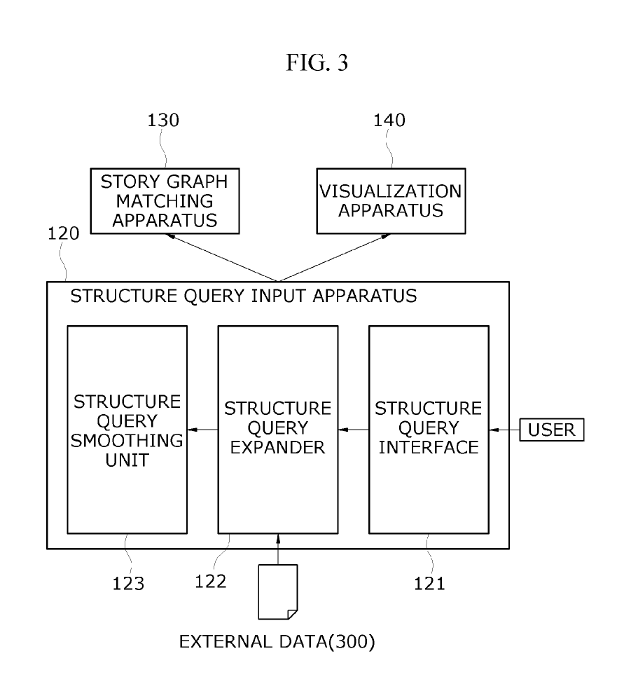

FIG. 3 is a diagram illustrating a configuration and operations of the structure query input apparatus which receives a structured query of a user according to an embodiment of the present invention.

As shown in FIG. 3, the structure query input apparatus 120 includes a structure query interface 121, a structure query expander 122, and a structure query smoothing unit 123.

Hereinafter, a configuration and operation of each of the elements of the structure query input apparatus 120 of FIG. 3 will be described in detail.

The structure query interface 121 receives keywords corresponding to nodes and relation information between the nodes using a user interface. The structure query interface 121 serves as a structure query input interface function for receiving a structure query input from the user. The structure query interface 121 receives information about nodes, keywords meant by the nodes, and edge information between the nodes from the user through an interface, such as display touch or a mouse. The user may select all or a part of the input structured query and make a request

The structure query expander 122 expands the user structure query through keywords associated with the input nodes using the external data 300, and expands the user structure query by extracting the relation information between the nodes from the external data 300. In response to a request for a structured query, the structure query expander 122 may selectively perform a structured query expansion function through the external data 300. The expansion is performed in two aspects. First, the structure query expander 122 may add a node on the basis of a particular node and a frequently occurring keyword. Then, the structure query expander 122 may add connection information when the relation information is observed in the external data 300 a threshold number of times or more, even though it is not present in the user query. In this case, the structure query expander 122 may expose the expanded information to the user so that the user manually determines whether to use the expanded information.

The structure query smoothing unit 123 generates connection information between the indirectly connected nodes through smoothing of the user structure query. The structure query smoothing unit 123 adjusts the structured query expanded by the structure query expander 122 using a structured query smoothing function. The structure query smoothing unit 123 performs the structured query smoothing function in the same manner as a story graph smoothing function of the story graph smoothing unit 115. Then, the user structure query is transmitted to the story graph matching apparatus 130 and the visualization apparatus 140.

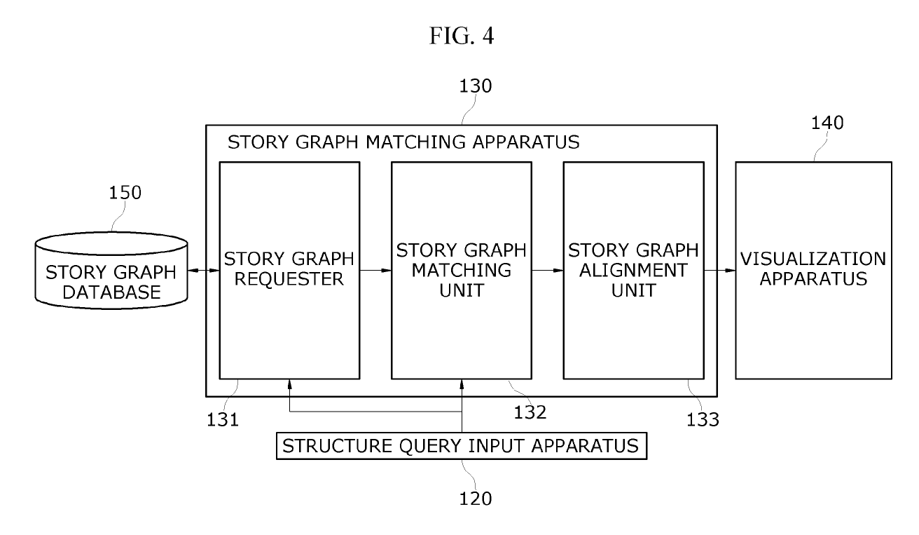

FIG. 4 is a diagram illustrating a configuration and operations of the story graph matching apparatus which matches all or a part of the query graph selected by a user to a story graph of video content according to an embodiment of the present invention.

As shown in FIG. 4, the story graph matching apparatus 130 includes a story graph requester 131, a story graph matching unit 132, and a story graph alignment unit 133.

Hereinafter, a configuration and operation of each of the elements of the story graph matching apparatus 130 of FIG. 4 will be described in detail.

The story graph requester 131 requests a related story graph on the basis of a keyword corresponding to a node included in the user structure query and receives the story graph from a database. When the user structure query is received from the structure query input apparatus 120, the story graph requester 131 performs a story graph request function to receive the related story graph on the basis of the pertinent user structure query. The story graph requester 131 receives all story graphs including nodes related to nodes (keywords) included in the user structure query from the story graph database 150 through the story graph request function. The story graph requester 131 transmits the received story graph and the user structure query to the story graph matching unit 132.

The story graph matching unit 132 identifies a similar sub-structure through node alignment between the user structure query and the story graph, calculates the similarity between the user structure query and the story graph according to the weight of the identified similar sub-structure and matches the user structure query to the story graph. In this case, the story graph matching unit 132 calculates the similarity by combining weights of the constituent nodes of the identified sub-structure with weights of the constituent edges of the sub-structure.

Specifically, the story graph matching unit 132 performs node alignment for received two graphs G and G′. Node alignment is a process of finding nodes having the same meanings and setting the same index. For example, the story graph matching unit 132 compares an entity “car” appearing in the story graph with an entity “vehicle” or “transportation” appearing in the user structure query, determines the degree of similarity therebetween, and sets the same index for the two entities. When the node alignment is completed, the story graph matching unit 132 identifies the same sub-structure appearing in both graphs and calculates the weight of the sub-structure. For example, when a structure of “node 1-node 2” is observed in both graphs G and G′, the story graph matching unit 132 calculates the similarity value by combining weights of the constituent nodes of the structure with weights of the constituent edges of the structure. A similarity function S(G, G′) between the two graphs may be defined as the following Formula 1.

$${\sum }_{i} {θ}_{i} ( G , {G}^{′} ) \qquad [ Formula 1 ]$$

Here, θᵢ denotes a weight of the i^{th} sub-structure. Meanwhile, a final similarity value may be calculated by normalization as shown in the following Formula 2.

$$\frac{S ( G , {G}^{′} )}{\sqrt{S ( G , G ) \cdot S ( {G}^{′} , {G}^{′} )}} \qquad [ Formula 2 ]$$

Here, a calculated similarity value is transmitted to the story graph alignment unit 133.

The story graph alignment unit 133 aligns and provides video content corresponding to the user structure query through the story graph matched in the story graph matching unit 132. The story graph alignment unit 133 aligns the video content corresponding to the user structure query according to the similarity value, and transmits the aligned video content to the visualization apparatus 140. In this case, the story graph alignment unit 133 may re-align the alignment result based on the calculated similarity on the basis of at least one of the user's preference of video content, consistency of the video with a previous search result, and importance of video content. The story graph alignment unit 133 may be expanded to include the user preference or the importance of content, in addition to the similarity value.

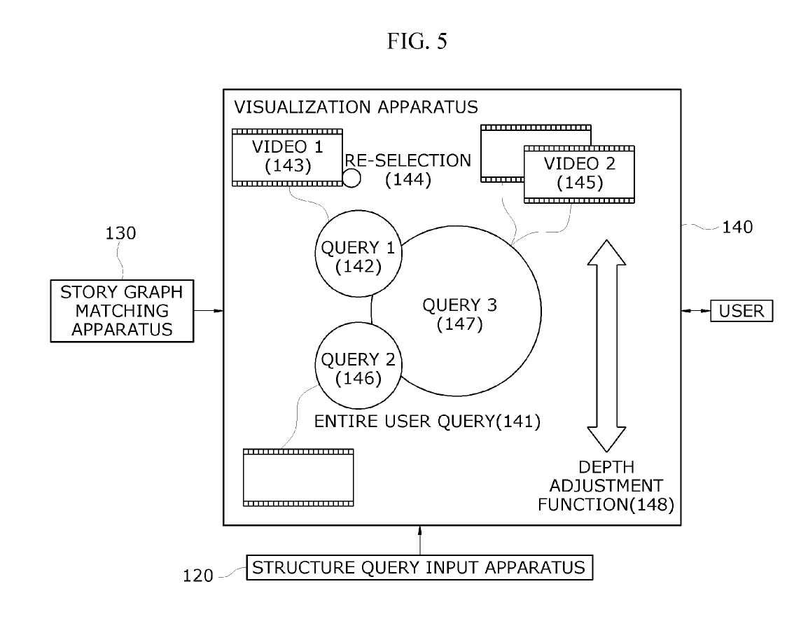

FIG. 5 is a diagram illustrating a configuration and operations of the visualization apparatus which visualizes a user's query graph and the searched video content according to an embodiment of the present invention.

As shown in FIG. 5, the visualization apparatus 140 transmits information to the user and interacts with the user on the basis of a received user structure query and a result obtained from the story graph matching apparatus 130.

The visualization apparatus 140 visualizes the entire region of the input user structure query and visualizes a selected region of the user structure query which is selectively queried by the user. In addition, for each of the selected regions, the visualization apparatus 140 connects the input user structure query with the video matching the user structure query and provides the result. That is, the visualization apparatus 140 visualizes first the entire region of the user structure query and provides the visualization result to the user. In addition, when the user performs a selective query, the visualization apparatus 140 displays the selected region as query 1 142. The visualization apparatus 140 connects corresponding video 1 143 with the displayed query and transmits the connected result to the user.

Then, the visualization apparatus 140 confirms a video content list associated with the connected video using a re-selection function. Thereafter, the user selects one or more video contents from the video content list, and the visualization apparatus 140 may connect the selected one or more video contents with the corresponding user structure query.

As described above, when the visualization apparatus 140 also displays the video re-selection function and the user selects the video re-selection function, the visualization apparatus 140 displays a video list of another similar video on the basis of the result received from the story graph matching apparatus 130. Then, the user may select one or more videos from the list. When a plurality of videos are selected, the visualization apparatus 140 may connect the plurality of videos, such as video 2 145, with one query and visualize the query.

In addition, the visualization apparatus 140 may determine a hierarchical structure of the user structure queries on the basis of the position and size of a region of the selected user structure query with respect to the entire region, and visualize a result for a structured query at a specific level through a depth adjustment function for the determined hierarchical structure.

As described above, the user may query all or a part of a single user structure query. Accordingly, the selected regions may overlap each other. In this case, a hierarchical relationship between query regions may be established according to the size and position. When there are two structured queries A and B, and when A includes a larger region than B and a certain region of B is included in A, A may be seen as a query at a higher level than B. For example, in FIG. 5, query 1 142 and query 2 146 are at lower levels than query 3 147, while query 1 142 and query 2 146 have the same level.

The visualization apparatus 140 may provide a depth adjustment function 148 to offer selective visualization to the user on the basis of the relation information. The visualization apparatus 140 may adjust a depth in a direction from a query at a higher level to a query at a lower level or vice versa through the depth adjustment function 148. In addition, the visualization apparatus 140 may visualize only a query at a specific level. This function may be provided to increase efficiency when a plurality of queries are visualized in a small-sized display, such as a tablet personal computer (tablet PC) or a head mounted device (HMD). The visualization apparatus 140 may also provide a function for editing a user structure query and deleting search results.

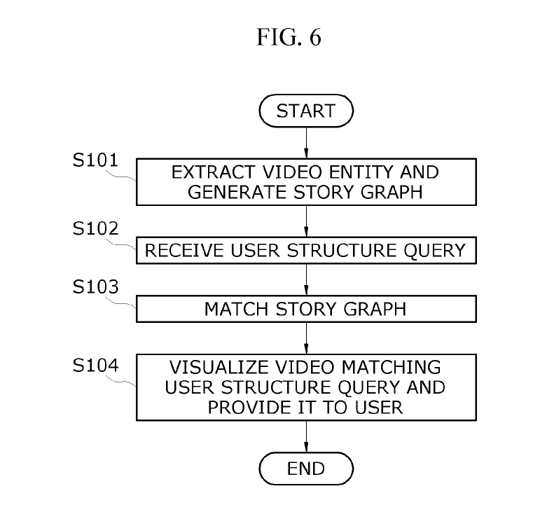

FIG. 6 is a flowchart illustrating a method of providing a content map service using a story graph of video content and a user structure query according to an embodiment of the present invention.

As shown in FIG. 6, a story graph generating apparatus 110 extracts video entities contained in video content 200 and entity relations between the entities, and generates a story graph on the basis of the extracted entity relations (S101).

A structure query input apparatus 120 receives a user structure query in the form of a graph (S102).

A story graph matching apparatus 130 calculates a similarity between a story graph and a user structure query input from the structure query input apparatus 120 from a similar sub-structure, and selects a matching video on the basis of the calculated similarity (S103).

A visualization apparatus 140 visualizes the user structure query received from the structure query input apparatus 120 and the video matching the user structure query in the story graph and provides the visualization result to the user (S104).

The story graph generated by the story graph generating apparatus 110 is stored in a story graph database 150.

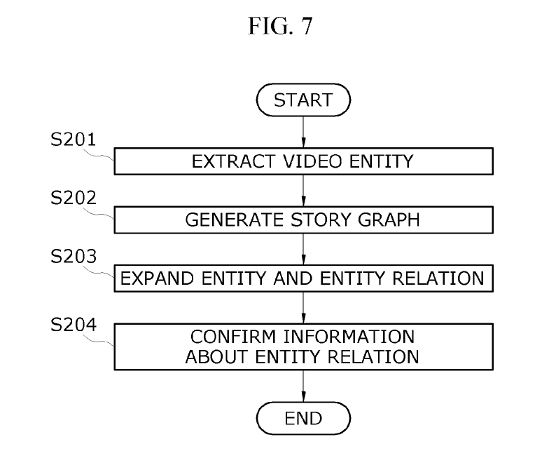

FIG. 7 is a flowchart illustrating a process of generating a story graph which is performed by the story graph generating apparatus according to the embodiment of the present invention.

The story graph generating apparatus 110 extracts image entities from input video content (S201).

Then, the story graph generating apparatus 110 generates a story graph consisting of a node weight list and an edge matrix by extracting entity relations between the extracted video entities (S202).

Then, the story graph generating apparatus 110 selectively expands the entities and entity relations using external data (S203).

Then, the story graph generating apparatus 110 identifies information about entity relations between indirectly connected entities using the node weight list and the edge matrix (S204).

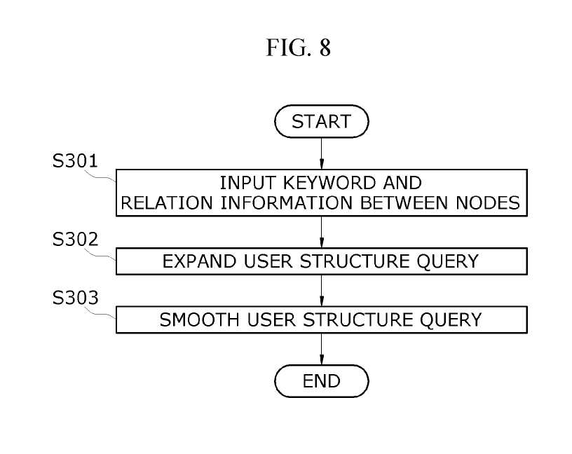

FIG. 8 is a flowchart illustrating a process of inputting a user structure query which is performed by the structure query input apparatus according to the embodiment of the present invention.

The structure query input apparatus 120 receives keywords corresponding to nodes and relation information between the nodes using a user interface (S301).

Then, the structure query input apparatus 120 expands the user structure query through the keywords associated with the input nodes using external data, and expands the user structure query by extracting the relation information between the nodes from the external data (S302).

Thereafter, the structure query input apparatus 120 generates connection information between indirectly connected nodes through smoothing of the user structure query (S303).

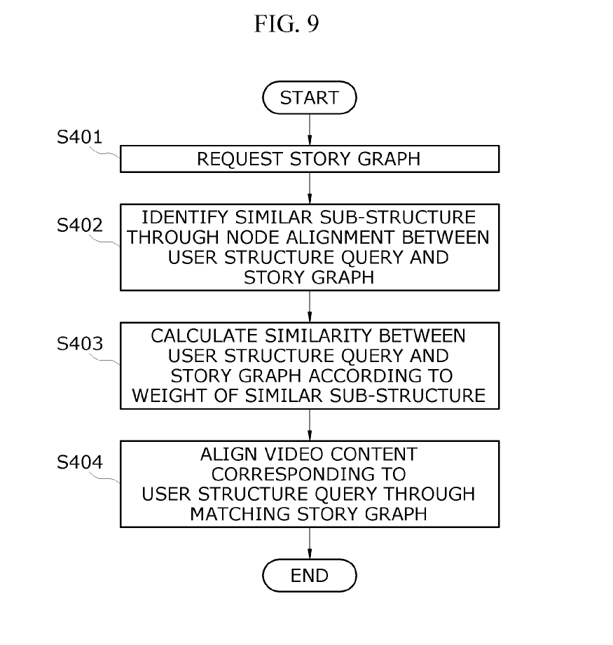

FIG. 9 is a flowchart illustrating a process of matching a story graph which is performed by the story graph matching apparatus according to the embodiment of the present invention.

The story graph matching apparatus 130 requests a related story graph on the basis of a keyword corresponding to a node included in the user structure query and receives the story graph from a database (S401).

Then, the story graph matching apparatus 130 identifies a similar sub-structure through node alignment between the user structure query and the story graph (S402).

Then, the story graph matching apparatus 130 calculates the similarity between the user structure query and the story graph according to the weight of the identified similar sub-structure and matches the user structure query to the story graph (S403).

Subsequently, the story graph matching apparatus 130 aligns and provides video content corresponding to the user structure query through the matching story graph (S404).

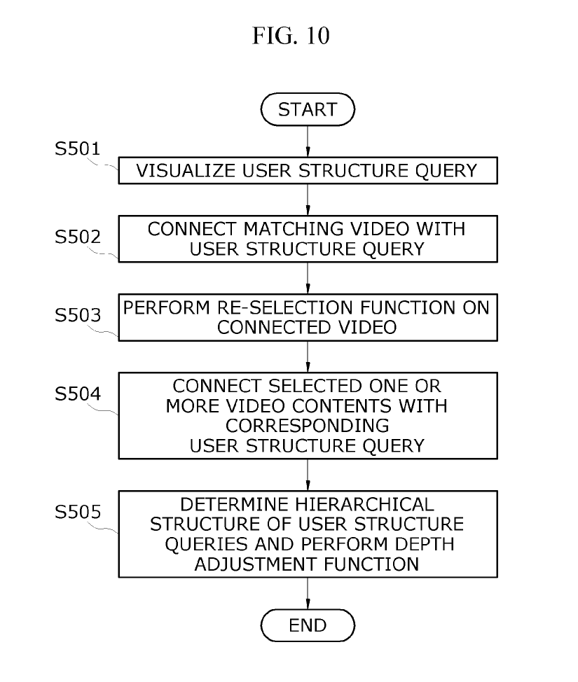

FIG. 10 is a flowchart illustrating a process of visualization performed by the visualization apparatus according to the embodiment of the present invention.

The visualization apparatus 140 visualizes the entire region of the input user structure query and visualizes a selected region of the user structure query which is selectively queried by the user (S501).

In addition, for each of the selected regions, the visualization apparatus 140 connects the input user structure query with the video matching the user structure query and provides the result (S502).

Then, the visualization apparatus 140 confirms a video content list associated with the connected video using a re-selection function (S503).

Subsequently, the user selects one or more video contents from the video content list, and the visualization apparatus 140 connects the selected one or more video contents with the corresponding user structure query (S504).

Thereafter, the visualization apparatus 140 determines a hierarchical structure of the user structure queries on the basis of the position and size of a region of the selected user structure query with respect to the entire region, and visualizes a result for a structured query at a specific level through a depth adjustment function for the determined hierarchical structure (S505).

According to the embodiments of the present invention, it is possible to derive a story graph of video content, combine video content matching a structured user structure query with all or a part of an input query and provide the combined result.

According to the embodiments of the present invention, unlike the related art in which search results are simply listed on the basis of a keyword-based query, it is possible to provide a user with video content which matches all or a part of an input structured user structure query, along with the user structure query in a visualization tool.

In addition, the embodiments of the present invention can increase search accuracy through a structured user structure query and provide visualization of video content according to the flow of the contents in the query, and thus can be applied to expansion and visualization of a mind map tool, production of educational contents, and the like.

While the present invention has been described in connection with what is presently considered to be practical exemplary embodiments, it should be understood that the present invention is not limited to the disclosed embodiments, but, on the contrary, is intended to cover various modifications and equivalent arrangements included within the spirit and scope of the appended claims.

What is claimed is:

1. An apparatus for providing a content map service using a story graph of video content and a user structure query, the apparatus comprising:
a story graph generating apparatus configured to extract video entities contained in video content and entity relations between the entities, and generate a story graph on the basis of the extracted entity relations;
a story graph database configured to store the generated story graph;
a structure query input apparatus configured to receive a user structure query in the form of a graph;
a story graph matching apparatus configured to calculate a similarity between the story graph and the input user structure query from a similar sub-structure, and select a matching video on the basis of the calculated similarity; and
a visualization apparatus configured to visualize the input user structure query and the video matching the user structure query in the story graph and provide a visualization result to a user.

2. The apparatus of claim 1, wherein the story graph generating apparatus includes:
a video entity extractor configured to extract video entities of the input video content; and
an entity relation extractor configured to generate a story graph consisting of a node weight list and an edge matrix by extracting entity relations between the extracted video entities.

3. The apparatus of claim 2, wherein the story graph generating apparatus further includes a story graph smoothing unit configured to selectively expand the entities and the entity relations using external data and identify information about entity relations between indirectly connected entities using the generated node weight list and edge matrix.

4. The apparatus of claim 1, wherein the structure query input apparatus includes:
a structure query interface configured to receive keywords corresponding to nodes and relation information between the nodes;
a structure query expander configured to expand the user structure query through the keywords associated with the input nodes using external data and expand the user structure query by extracting relation information between the nodes from the external data; and
a structure query smoothing unit configured to generate connection information between indirectly connected nodes through smoothing of the user structure query.

5. The apparatus of claim 1, wherein the story graph matching apparatus includes:
a story graph requester configured to request a related story graph on the basis of a keyword corresponding to a node included in the user structure query and receive the story graph from a database;
a story graph matching unit configured to identify the similar sub-structure through node alignment between the user structure query and the story graph, calculate the similarity between the user structure query and the story graph according to a weight of the identified similar sub-structure, and match the user structure query to the story graph; and
a story graph alignment unit configured to align and provide video content corresponding to the user structure query through the matching story graph.

6. The apparatus of claim 5, wherein the story graph matching unit calculates the similarity by combining weights of constituent nodes of the identified sub-structure with weights of constituent edges of the sub-structure.

7. The apparatus of claim 5, wherein the story graph alignment unit re-aligns the alignment result based on the calculated similarity on the basis of at least one of the user's preference of video content, consistency of a video with a previous search result, and importance of video content.

8. The apparatus of claim 1, wherein the visualization apparatus visualizes an entire region of the input user structure query, visualizes a selected region of the user structure query which is selectively queried by the user, connects the input user structure query with the video matching the user structure query for each of the selected regions and provide the result.

9. The apparatus of claim 8, wherein the visualization apparatus confirms a video content list associated with the connected video using a re-selection function, selects one or more video contents from the video content list, and connects the selected one or more video contents with the corresponding user structure query.

10. The apparatus of claim 8, wherein the visualization apparatus determines a hierarchical structure of user structure queries on the basis of a position and size of a region of the selected user structure query with respect to the entire region, and visualizes a result for a structured query at a specific level through a depth adjustment function for the determined hierarchical structure.

11. A method of providing a content map service using a story graph of video content and a user structure query, the method comprising:
extracting video entities contained in video content and entity relations between the entities and generating a story graph on the basis of the extracted entity relations;
receiving a user structure query in the form of a graph;
calculating a similarity between the story graph and the input user structure query from a similar sub-structure and selecting a matching video on the basis of the calculated similarity; and
visualizing the input user structure query and the video matching the user structure query in the story graph and providing a visualization result to a user.

12. The method of claim 11, wherein the generating of the story graph includes extracting video entities of the input video content and generating a story graph consisting of a node weight list and an edge matrix by extracting entity relations between the extracted video entities.

13. The method of claim 12, wherein the generating of the story graph further includes:
selectively expanding the entities and the entity relations using external data; and
identifying information about entity relations between indirectly connected entities using the generated node weight list and edge matrix.

14. The method of claim 11, wherein the receiving of the user structure query includes:
receiving keywords corresponding to nodes and relation information between the nodes;
expanding the user structure query through the keywords associated with the input nodes using external data, and expanding the user structure query by extracting relation information between the nodes from the external data; and
generating connection information between indirectly connected nodes through smoothing of the user structure query.

15. The method of claim 11, wherein the selecting of the matching video includes:
requesting a related story graph on the basis of a keyword corresponding to a node included in the user structure query and receiving the story graph;
identifying the similar sub-structure through node alignment between the user structure query and the story graph, calculating the similarity between the user structure query and the story graph according to a weight of the identified similar sub-structure, and matching the user structure query to the story graph; and
aligning and providing video content corresponding to the user structure query through the matching story graph.

16. The method of claim 15, wherein the matching includes calculating the similarity by combining weights of constituent nodes of the identified sub-structure with weights of constituent edges of the sub-structure.

17. The method of claim 15, wherein the aligning and providing of the video content includes re-aligning the alignment result based on the calculated similarity on the basis of at least one of the user's preference of video content, consistency of a video with a previous search result, and importance of video content.

18. The method of claim 11, wherein the providing of the visualization result includes:
visualizing an entire region of the input user structure query and visualizing a selected region of the user structure query which is selectively queried by the user; and
connecting the input user structure query with the video matching the user structure query for each of the selected regions and providing a result.

19. The method of claim 18, wherein the providing of the visualization result further includes:
confirming a video content list associated with the connected video using a re-selection function;
selecting one or more video contents from the video content list; and
connecting the selected one or more video contents with the corresponding user structure query.

20. The method of claim 18, wherein the providing of the visualization result further includes:
determining a hierarchical structure of user structure queries on the basis of a position and size of a region of the selected user structure query with respect to the entire region; and
visualizing a result for a structured query at a specific level through a depth adjustment function for the determined hierarchical structure.
